(19) United States
(12) Patent Application Publication
(10) Pub. No.: US 2007/0054020 A1
(43) Pub. Date: Mar. 8, 2007

(54) Method of manufacturing block-type freeze-dried soybean paste (miso)

(75) Inventor: Michimasa Kumagai, Yokohama-shi (JP)

Correspondence Address: COOPER & DUNHAM, LLP, 1185 AVENUE OF THE AMERICAS, NEW YORK, NY, 10036, US

(73) Assignee: Nagatanien Co. Ltd.

(21) Appl. No.: 11/516,203

(22) Filed: Sep. 5, 2006

(30) Foreign Application Priority Data
Sep. 6, 2005 (JP) 2005-257944
Jun. 8, 2006 (JP) 2006-160136

(51) Int. Cl. A23L 3/36

(52) U.S. Cl. 426/524; 426/634

(57) ABSTRACT

A method of manufacturing a freeze-dried block miso with an excellent flavor at a high productivity without increasing the amount of water added, which increases the drying cost, includes filling hydrated miso prepared by adding water to miso followed by mixing, into a molding container having a shape of an inverted frustum of a cone, with a narrow bottom portion and a wide opening at an upper portion, in which a plurality of grooves are formed in the inner circumferential side wall such as to run from the bottom portion to the upper portion, and chilling the container to harden the hydrated miso by chill, followed by freeze-drying.

### CROSS-REFERENCE TO RELATED APPLICATIONS

This application is based upon and claims the benefit of priority from prior Japanese Patent Applications No. 2005-257944, filed Sep. 6, 2005; and No. 2006-160136, filed Jun. 8, 2006, the entire contents of both of which are incorporated herein by reference.

### BACKGROUND OF THE INVENTION

1. Field of the Invention

The present invention relates to a method of manufacturing a block-type freeze-dried miso (soybean paste), and more specifically to a method of manufacturing a block-type freeze-dried miso having an excellent solubility and the natural flavor of fresh bean paste.

2. Description of the Related Art

Nowadays, instant miso soups that use freeze-dried miso are very popular even in homes. There are various forms of freeze-dried miso (soybean paste), that is, for example, powder, granules and block. The these freeze-dried miso materials are generally manufactured in the following manner. That is, fresh bean paste is spread on a metal-made drying tray and then preliminarily frozen. After that, the fresh bean paste is freeze-dried.

However, the freeze-dried miso thus manufactured exhibits a hard and consolidated state, which is not easily soluble. Thus, as it is, if hot water is poured onto the miso product, it is conventionally extremely difficult to reconstitute of the fresh state. The main factor for the insolubility of the freeze-dried miso is that the fresh soybean paste is dried without being frozen during the freeze-drying, and thus the miso is practically subjected to an analogous operation to vacuum-drying.

More specifically, as the freeze-drying proceeds, the moisture of miso (soybean paste) moves to the upper surface, which is a moisture evaporating surface, of the miso material. As the moisture moves towards the upper surface, other soluble components of the miso move to the upper surface as well. Further, as the moisture evaporates, regional condensation of soluble components occurs in the upper surface, which creates hard and brown dry materials.

In order to solve the above-described problem, there has been a method proposed as disclosed in Jpn. Pat. Appln. KOKOKU Publication No. 57-43230, in which 20 to 200 parts by weight of water is added to 100 parts by weight of miso and then blended, followed by preliminary freezing and then freeze drying. However, such a method of freeze-drying miso with an improved reconstitutability, entails a problem of the degradation of flavor due to a great amount of water added thereto.

That is, with the conventional freeze-drying technique, the temperature of miso cannot be lowered down to its eutectic point to have it completely frozen. As a solution to this drawback, the above-mentioned prior art increases the ice crystal part in the miso so as to relatively lower the liquid phase part, and thus make the miso material porous to enhance the drying efficiency. However, the dried material thus obtained becomes more porous in proportional to the amount of water added, and further suppresses its browning and increase its solubility. With this method, on the other hand, the natural flavor of miso is lost and the cost for drying is increased due to an increase in the amount of dehydration.

In the meantime, Jpn. Pat. Appln. KOKAI Publication No. 8-103240 discloses a method of making a non-brittle dried solid miso with an improved reconstitutability of miso, an excellent drying efficiency and a resistive to deformation while being dried. In this method, the miso is freeze-dried while the water content thereof is adjusted to 65 to 75% by weight, and the miso contains a predetermined amount of viscosity-increasing polysaccharides to prevent the brittleness caused by hydration, swelling by foaming, or deformation. However, according to this method, since the viscosity-increasing polysaccharides are added, the flavor of the miso is inevitably deteriorated. Therefore, this method entails a problem of a deteriorated flavor, which is critical to the product value such as of miso. Under these circumstances, this method is not commercially practical.

Further, Jpn. Pat. Appln. KOKAI Publication No. 2004-215654 discloses a method of freeze-drying miso by subliming and evaporating moisture from the entire surface of the miso. According to this method, hydrated and mixed miso is placed on a tray or the like, then preliminarily frozen after decreasing the hydration amount of the miso mixture to 30 to 60 parts by weight with respect to 100 parts by weight of miso, and the resultant is transferred to another air-permeable container where it is to be freeze-dried.

According to this prior art technique, the hydration amount of miso is decreased and the miso is filled into an air-permeable container so that the moisture is sublimed and evaporated from the entire surface of the miso material. In this manner, the amount of moisture sublimed in an initial stage is large, and therefore the liquid phase containing mainly unfrozen water and dissolved components of the miso are abruptly highly concentrated, thus quickly dried and hardened. The freeze-dried miso product obtained with this method exhibits excellent solubility and form retention properties.

However, with the above-described reference invention, fluid miso prepared by hydrating and mixing is filled as it is in an air-permeable container, the fluid portion of the miso may leak out from the air openings of the container. In order to avoid this drawback, this reference invention provides such a solution that hydrated and mixed fluid miso is temporarily put into a forming tray having no air permeability, where it is chilled and hardened by chill. After that, the chill-hardened miso is unloaded from the forming tray, and it must be transferred to another porous plate or mesh container, which is air-permeable, so as to be freeze-dried. For this reason, this method entails a drawback, especially, in productivity.

### BRIEF SUMMARY OF THE INVENTION

An object of an aspect of the present invention is to obtain a freeze-dried block miso having an excellent natural flavor without increasing the amount of addition of water, which causes the drying cost, at a high productivity. Another object is to obtain a freeze-dried block miso having an excellent natural flavor without adding an additive. Further, still another object of the present invention is to obtain a freeze-dried block miso having an excellent natural flavor at a high productivity without having to carry out laborious operations including transferring miso from one container to another special container during the production process.

In order to achieve one of the above-described objects, there is provided, according to the present invention, a hydrated miso having a water content of 58 to 67% by weight by adding water to the miso followed by mixing. According to this aspect of the invention, the hydrated miso is filled into a molding container having a shape of an inverted frustum of a cone, with a narrow bottom portion and a wide opening at an upper portion, in which a plurality of grooves are formed in the inner circumferential side wall such as to run from the bottom portion to the upper portion. Further, according to the present invention, the hydrated miso is chilled to harden it by chill. Furthermore, according to the present invention, the chill-hardened miso is freeze-dried.

Moreover, according to another aspect of the present invention, the hydrated miso having the above-specified water content and ingredients, which are separated from each other, are made into layers, and the layers are filled into the molding container, which are chilled to prepare the chill-hardened hydrated miso. After that, the chill-hardened hydrated miso is freeze-dried.

According to the just-described aspect of the present invention, the sublimation and evaporation of the water content is made to occur not only from the surface of the miso but also the bottom surface and side surfaces while the miso is filled in the molding container while freeze-drying the miso. With this invention, the solubility of the freeze-dried block miso when hot water is poured thereto can be significantly improved. Further, according to this aspect of the invention, a large amount of water is not added unlike the conventional method of manufacturing freeze-dried miso, and therefore the natural flavor can be improved.

Additional objects and advantages of the invention will be set forth in the description which follows, and in part will be obvious from the description, or may be leaned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIGS. 1A to 1F are diagrams each showing a respective state in which the hydrated miso is filled into a molding container having a shape of a frustum of a cone turned upside down, with a narrow bottom portion and a wide opening at an upper portion, in which a plurality of grooves are formed in the inner circumferential side wall such as to run from the bottom portion to the upper portion;

FIG. 2 is a perspective view showing a freeze-dried block miso obtained by an embodiment of the present invention; and

FIG. 3 is a perspective view showing a freeze-dried miso obtained by another embodiment of the present invention, in which miso and ingredients are separated into two layers stacking one on another.

### DETAILED DESCRIPTION OF THE INVENTION

According to the present invention, a hydrated and mixed soybean paste (miso) is filled into a molding container having a such shape that a frustum of a cone is turned upside down, and the miso is chilled, followed by freeze-drying. The soybean paste (miso) used in the present invention includes a seasoned miso which is prepared by seasoning rice miso, bean miso or the like. Further, the miso of the present invention includes instant miso soup materials which contain ingredients such as spinach, seaweed, tofu (soybean curd) and deep-fried tofu.

Alternatively, in place of mixing ingredients into miso, it is possible to prepare an ingredient layer and a hydrated miso layer separately and put them in a molding container to make layers of one stacking on another. In this case, for example, ingredients are put in the molding container to make a layer of a predetermined thickness, and then a predetermined amount of a shape retention material of a solution of gelatin, starch, dextrin or the like, is poured onto the layer. Then, the hydrated miso is filled into the container, thus making a two-layer structure of the ingredients and hydrated miso.

In this invention, water is added to the miso and mixed to blend the water content in order to increase the reconstitutability of the miso when hot water is poured thereto and the drying efficiency. In this manner, when chilling the miso for hardening by chill, the amount of ice crystal is relatively more than the amount of the liquid phase portion of the miso. In this case, water is added in such a range of amount that would form an excellent shape retaining property and not cause an adverse effect on the reconstitutability, and therefore, the water content of the miso is adjusted to 58 to 67% by weight.

Usually, the water content of miso is 45% by weight (Food Composition Table, 5th edition). Therefore, in order to make it to have a water content of 58 to 67% by weight specified by the present invention as mentioned above, the amount of water added should be 30 to 60% by weight in terms of the weight of the miso.

In the present invention, the hydrated miso is hardened by chill, and the hardened miso is freeze-dried. Here, in this case, while the miso undergoes in a vacuum state during the freeze-drying, it expands due to the evaporation of the water content and air in the miso placed in the molding container. However, if the amount of water added to the miso is excessively large or small, the miso does not expand. More specifically, if the amount of water is excessively large, the viscosity of the miso appropriate for expansion is lost. As a result, it is not possible to expand the miso due to the water content and air in the miso during the freeze-drying. On the other hand, when the amount of water is excessively small, the viscosity of the miso becomes excessively high. As a result, a sufficient expansion of the miso, which occurs with the evaporation of the water content and air, cannot be achieved.

Further, the expansion degree of the hydrated miso is influenced by the chilling temperature in the freeze-drying. More specifically, as the temperature is lower, the expansion under vacuum in the freeze-drying becomes less. Therefore, the expanding degree can be controlled by adjusting the chilling temperature.

Furthermore, the reconstitutability and shock resistance of the freeze-dried block miso greatly depend on the amount of water added thereto, it is preferable that the amount of water should be adjusted in the above-described range in view of another factor of the drying cost. In particular, when the water content of the miso exceeds 67% by weight, the shape retaining property of the block cannot be maintained and therefore it becomes very brittle. On the other hand, when the water content of the miso is less than 58% by weight, the miso block becomes hard and dense, and therefore the reconstitutability is degraded. The addition of water and mixing are carried out appropriately using a mixer or a kneader.

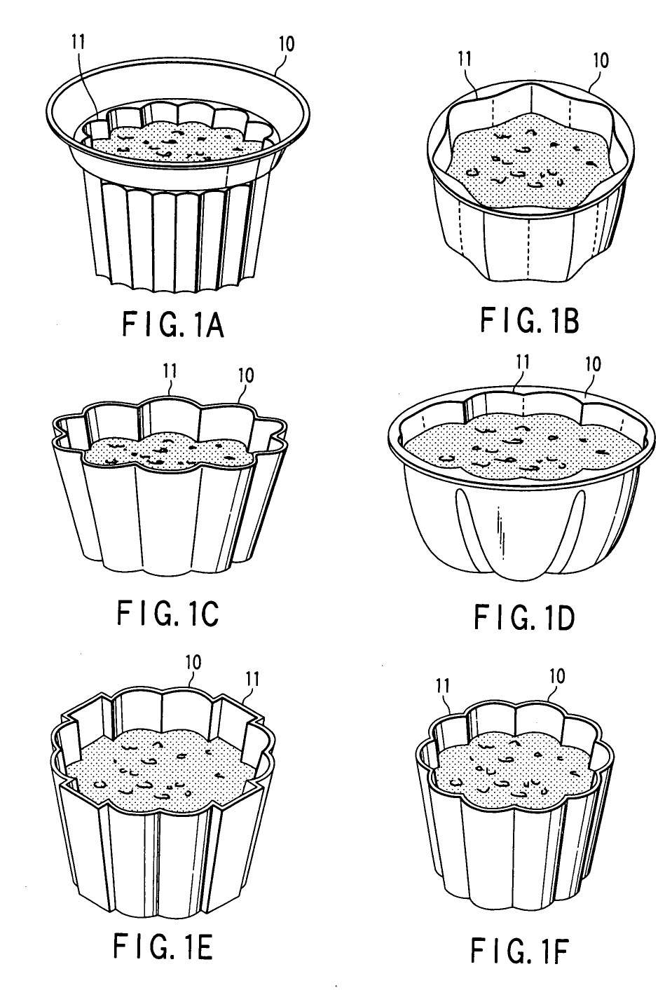

Next, the hydrated miso thus obtained is filled into a molding container having a shape of a frustum of a cone turned upside down, with a narrow bottom portion and a wide opening at an upper portion, in which a plurality of grooves are formed in the inner circumferential side wall such as to run from the bottom portion to the upper portion. Usable examples of the molding container having a shape of a frustum of a cone turned upside down are shown in FIGS. 1A to 1F denoted by reference numeral 10, although the present invention is not limited to these examples. For example, the bottom surface of the molding container is not necessarily flat, but it may be formed into an arbitrary irregular form.

In the inner circumferential side wall of the molding container 10, a plurality of grooves 11 are formed such as to run from the bottom portion to the opening at the upper portion thereof. The form of the grooves 11 is not particularly limited as long as the form can make the space inside the container and the external free space enables communicate to each other when the miso inside the container moves upward along the inner wall of the container due to the expansion that occurs the freeze-dying the miso and therefore the surface of the hydrated miso departs from the inner side of the container.

The arrangement of the grooves 11 may be determined appropriately as needed in accordance with the state of the hydrated miso filled in the molding container. In usual cases, the grooves are formed to be distributed at substantially uniform intervals along the circumferential directions at the opening of the container. Each groove 11 is usually formed to have such a length that covers the bottom portion of the container to the opening thereof. However, in the case where the hydrated miso is not filled completely to the upper end of the container, it is not necessarily formed to the upper end of the container.

The angle between the bottom portion and the side wall of the molding container 10 is adjusted to 100 to 130°. The adjustment of the angle is carried out to facilitate the upward movement of the chill-hardened material of the hydrated miso inside the molding container 10 when it is expanded during the freeze-drying. If the angle between the bottom surface and inner wall surface of the molding container 10 is smaller than 100° and the side wall stands straight up in the vertical direction, the chill-hardened material of the hydrated miso cannot move upwards. As a result, it is not possible to create a space in the bottom section of the molding container 10.

On the other hand, if the angle between the bottom surface and inner wall surface of the molding container 10 is larger than 130° and the side wall is inclined towards the direction of the bottom surface, the miso cannot expand sufficiently to match the side of the container. In this case as well, it is not possible to move the chill-hardened material upwards. Further, as shown in FIG. 1D, the bottom portion and the side wall of the molding container 10 may be formed to have a curved surface.

Further, in the present invention, the effective volume of the molding container (the volume filled with the hydrated miso) is set to be 30% or more of the inner volute of the container, and the volume is limited to 100 mL or less. In the case where the amount of the hydrated miso filled is excessive, the chill-hardened material of the miso cannot easily move upwards due to its own weight, and therefore the sublimation and evaporation of water from the bottom section is interfered with. Thus, the object of the invention cannot be achieved. Further, when the block member increases in size, the surface area ratio to the weight of the miso becomes small. Consequently, the thermal conductivity is degraded and the drying requires a longer time. As a result, the conditions falling out of the above-specified range, is not appropriate for actual production.

As to the material for the molding container, plastic or metal is usually used. It is more desirable that the inner surface of the molding container is made smooth and to have a water expellant effect so as to facilitate the movement of the chill-hardened material of the hydrated miso in the molding container. Therefore, it is preferable that the inner side of the molding container is subjected to a coating treatment with a fluorocarbon resin or silicon resin in accordance with necessity. A number of containers each identical to the molding container may be used separately. However, it is alternatively possible that a plurality of similar molding containers are made continuously in a large metal plate or plastic sheet.

The hydrated miso filled in the above-described molding container is loaded in a refrigerator or the like along with its container and hardened by chill there. The hardness of the chill-hardened hydrated miso is set to a drilling stress of 1.0 to 5.0 kg. Here, the drilling stress indicates the maximum stress detected when miso filled in a container is drilled with a spherical metal plunger having a diameter of 6 mm at a drilling speed of 5 cm/minute to such a depth that the plunger is substantially buried in the surface portion of the miso, using a rheometer (RT-2010-CW of Rheotech Co. Ltd.)

When the drilling stress of the chill-hardened material of the hydrated miso is in the above-described range, an appropriate expansion can be achieved under a reduced pressure in the dry-freezing, and thus a gap that communicates to an external free space is created in the container. If the drilling stress is more than the upper limit of the range, the miso is in a hard and solid frozen state and therefore the sufficient expansion of the miso cannot be obtained.

On the other hand, if the drilling stress is less than the lower limit of the range, the chill-hardened material of the miso is so soft that the air and vapor inside cannot be retained in the miso. Thus, the air and vapor are released from the miso when the pressure is reduced and therefore a sufficient expansion of the miso cannot be obtained. In order for the chill-hardened material to achieve the above-described drilling strength, hydrated miso in the above-described state should be kept in a freezer of −10 to −30° C.

After that, the miso hardened by chill to be adjusted to a predetermined hardness is subjected to the next step, the freeze-drying while being kept in the molding container. In the starting period of the freeze-drying, the miso arises towards the opening side of the container as the degree of vacuum in the drying chamber is decreased due to the expansion of the hydrated miso and the vapor created by sublimation as well as the air pressure from the bottom section of the miso. Consequently, gaps are created in the bottom portion and inner side surface of the molding container, and the gaps communicate to the outside of the molding container via grooves made in the inner wall of the container. With this structure, while the miso is filled in the molding container, the miso is dried in such a state that it is not substantially in contact with the container at a large area ratio.

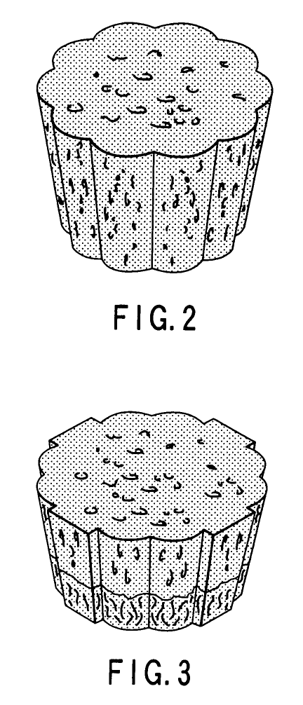

FIGS. 2 and 3 each illustrates an example of the freeze-dried block miso thus obtained. The freeze-dried block miso has such a strength that the final product can be made into a block shape, and therefore unlike the conventional technique, the present invention does not require a paper-made protective member or a plastic tray for protecting the block miso. Further, in terms of flavor, the freeze-dried block miso of the present invention can maintain the flavor and taste of fresh miso and suppress the oxidization of the miso during the preservation, unlike the conventional excessively porous product manufactured from the dried material of the hyper-hydrated miso.

### EXAMPLE 1

150 g (50% by weight with respect to the weight of the miso) of water and 23 g of seasonings (8 g of sodium glutamate, 11.5 g of dried bonito powder, 1.5 g of yeast extract powder, 0.5 g of nucleic acid-based seasoning and 1.5 g of seaweed extract powder) were added to 300 g of light-colored koji (rice-molted) miso having a water content of 46%. Then, they were mixed and dispersed uniformly with a rubber spatula. Thus obtained seasoned miso paste had a water content of 60% by weight.

Next, 40 g of the seasoned miso paste was filled in a molding container having a shape of a frustum of a cone turned upside down, with a narrow bottom portion and a wide opening at an upper portion, in which a plurality of grooves are formed in the inner circumferential side wall such as to run from the bottom portion to the upper portion. The molding container was an aluminum-made container having a volume of about 70 ml, which had a diameter of 33 mm in the bottom portion, a diameter of 65 mm in the opening portion and a height 40 mm, with grooves formed in the inner wall surface and having a depth of 4 mm and substantially a U shape in the cross section running normal to the longitudinal direction and formed from the bottom portion and opening portion along the entire circumstance of the container at intervals of 15 mm, and an angle of 110 degrees made between the bottom portion and the side wall.

As Comparative Example 1, 40 g of the same seasoned miso paste was filled in an aluminum-made molding container having a having a volume of about 65 ml, which had a diameter of 44 mm in the bottom portion, a diameter of 55 mm in the opening portion and a height of 32 mm, with the inner wall formed to have a smooth curved surface and an angle of 95 degrees made between the bottom portion and the side wall.

The molding containers filled with the miso according to Example 1 and Comparative Example 1 were both placed in a freezer of −25° C. and let stand there for 5 hours to be chilled and solidified. The solidified miso was measured in terms of drilling stress, and the results indicated that both cases fell in a range of 0.9 to 1.2 kg. After that, the containers were placed on a drying tray and the tray was placed directly on a shelf of a freeze-drying machine, where they were subjected to freeze-drying at a degree of vacuum of 40 to 90 Pa and a shelf temperature of 60 to 40° C. Thus, the freeze-dried miso blocks were obtained.

The freeze-dried miso blocks were observed and the following results were obtained. That is, the freeze-dried miso block of Example 1 did not exhibit foaming, browning or surface hardening but had minute and fine gaps inside. It was attempted to break the block into two by hands, but it was hard to break it. Nevertheless, when the miso block was put in a cup and hot water was poured thereto, it quickly dissolved and a miso soup with a flavor as good as that of fresh miso was obtained.

By contrast, the freeze-dried miso block of Comparative Example 1 exhibited a similar state to that of Example 1 with regard to the upper surface corresponding to the opening portion of the container, but the miso became hard and browned in the section from the side surface to the bottom surface. When hot water was poured onto this block, it required some time to dissolve and the miso soup released an increased sour flavor. Thus, the quality was degraded.

### EXAMPLE 2

In a similar manner to that of Example 1, 163 g (54% by weight with respect to the weight of the miso) of water and the same seasonings was those of Example 1 were mixed into 300 g of light-colored koji (rice-molted) miso having a water content of 46%, and thus a seasoned miso paste having a water content of 62% by weight was obtained.

Next, 40 g of the seasoned miso paste was filled in an aluminum-made molding container of the same shape and size as those of Example 1 and the container filled with the miso was placed in a freezer of −25° C. and let stand there for 5 hours to be chilled and solidified. After that, the container was placed a drying tray and the tray was placed directly on a shelf of a freeze-drying machine, where it was subjected to freeze-drying at a degree of vacuum of 40 to 90 Pa and a shelf temperature of 60 to 40° C. Thus, the freeze-dried miso block was obtained.

The freeze-dried miso block was observed and the following results were obtained. That is, the freeze-dried miso block of Example 2 did not exhibit foaming, browning or surface hardening but had a structure with minute and fine gaps made inside. It was attempted to break the block into two by hands, but it was hard to break it. Nevertheless, when hot water was poured thereto, it quickly dissolved and a miso soup with a flavor as good as that of fresh miso was obtained.

As Comparative Example 2, 88 g of water was added similarly thereto and thus a seasoned miso paste having a water content of 55% by weight was obtained. As Comparative Example 3, 293 g of water was added similarly thereto and thus a seasoned miso paste having a water content of 70% by weight was obtained.

Next, 40 g of the seasoned miso paste of each of Examples 2 and 3 was filled in an aluminum-made molding container of the same shape and size as those of Example 1 and the container filled with the miso was placed in a freezer of −25° C. and let stand there for 5 hours to be chilled and solidified in each case. After that, the containers were placed on a drying tray and the tray was placed directly on a shelf of a freeze-drying machine, where they were subjected to freeze-drying at a degree of vacuum of 40 to 90 Pa and a shelf temperature of 60 to 40° C. Thus, the freeze-dried miso blocks were obtained.

Each of the freeze-dried miso blocks of Comparative Examples 2 and 3 was browned in the section from the side surface to the bottom surface. Further, each became hard and did not expand. When hot water was poured onto this block, it required some time to dissolve and the miso soup released an increased sour flavor.

### EXAMPLES 3 and 4

In a similar manner to that of Example 1, a seasoned miso paste having a water content of 60% by weight was obtained in each of Examples 3 and 4. Next, in both cases, 40 g of the seasoned miso paste was filled in an aluminum-made molding container of the same shape as that of Example 1. However, the molding container used in Example 3 had a volume of about 130 ml and an angle of 120 degrees between the bottom portion and the side wall.

On the other hand, the molding container used in Example 4 had a volume of about 150 ml and an angle of 130 degrees. Each of these containers filled with the miso was placed in a freezer of −25° C. and let stand there for 5 hours to be chilled and solidified as in Example 1. After that, the containers were placed on a drying tray and the tray was placed directly on a shelf of a freeze-drying machine, where it was subjected to freeze-drying at a degree of vacuum of 40 to 90 Pa and a shelf temperature of 60 to 40° C. Thus, the freeze-dried miso block was obtained.

The freeze-dried miso blocks were observed and the following results were obtained. That is, each of the freeze-dried miso blocks did not exhibit foaming, browning or surface hardening but had a structure with minute and fine gaps made inside as in the case of Example 1. Further, it was attempted to break the block into two by hands, but it was hard to break it. Nevertheless, when hot water was poured thereto, it quickly dissolved and a miso soup with a flavor as good as that of fresh miso was obtained.

### EXAMPLE 5

In a similar manner to that of Example 1, a seasoned miso paste having a water content of 60% by weight was obtained. Next, 40 g of a miso ingredient material including pre-blanched vegetables of cabbage, green onion and filed peas, pieces of deep-fried tofu (soybean curd) and seaweed was filled in a polypropylene container having substantially a square bottom of each side of 35 mm, a square opening of each of side of 60 mm and a height of 40 mm, such as shown in FIG. 1E. Then, 10 ml of 0.5%-gelatin liquid was added on the ingredient material and the resultant was once frozen in a freezer.

After that, 25 g of the seasoned miso paste prepared in the beginning was stacked on the frozen ingredient material, and then the container was placed in a freezer of −25° C. and let stand there for 5 hours to be chilled and solidified, followed by freeze-drying as in Example 1. The freeze-dried miso block thus obtained had a two layer structure in which the ingredients and miso were clearly separated, and the structure was dense and hard. When hot water was poured thereto, it quickly dissolved and a miso soup with a good flavor was obtained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of manufacture a freeze-dried block soybean paste, comprising:
preparing hydrated soybean paste by adding water to soybean paste and mixing them together;
filling the hydrated soybean paste into a container having a shape of an inverted frustum of a cone, with a narrow bottom portion and a wide opening at an upper portion, in which a plurality of grooves are formed in an inner circumferential side wall such as to run from the bottom portion to the upper portion;
hardening the hydrated soybean paste by chilling the hydrated soybean paste; and
freeze-drying the soybean paste hardened by chill.

2. A method of manufacture a freeze-dried block soybean paste, comprising:
preparing hydrated soybean paste by adding water to soybean paste and mixing them together;
filling one of the hydrated soybean paste and an ingredient into a molding container having a shape of an inverted frustum of a cone, with a narrow bottom portion and a wide opening at an upper portion, in which a plurality of grooves are formed in an inner circumferential side wall such as to run from the bottom portion to the upper portion;
filling an other one of the hydrated soybean paste and the ingredient on the one in the container filled in the previous filling, thereby making layers one stacking on another;
hardening the hydrated soybean paste by chilling the hydrated soybean paste; and
freeze-drying the soybean paste hardened by chill.

3. The method according to claim 1, wherein
a water content of the hydrated soybean paste is set to 58 to 67% by weight and
the hardening by chill is carried out at such a temperature that hydrated soybean paste is expanded when a pressure is reduced in an initial stage of drying in the freeze-drying.

4. The method according to claim 2, wherein
a water content of the hydrated soybean paste is set to 58 to 67% by weight and
the hardening by chill is carried out at such a temperature that hydrated soybean paste is expanded when a pressure is reduced in an initial stage of drying in the freeze-drying.

5. The method according to claim 1, wherein
an angle made between the bottom portion and side wall of the molding container is set to 100 to 130°, and
a volume of the hydrated soybean paste filled into the container is 30% by volume of a volume of the container or more but not more than 100 mL.

6. The method according to claim 2, wherein
an angle made between the bottom portion and side wall of the molding container is set to 100 to 130°, and
a volume of the hydrated soybean paste filled into the container is 30% by volume of a volume of the container or more but not more than 100 mL.

7. The method according to claim 1, wherein
a water content of the hydrated soybean paste is set to 58 to 67% by weight,
the hardening by chill is carried out at such a temperature that hydrated soybean paste is expanded when a pressure is reduced in an initial stage of drying in the freeze-drying,
an angle made between the bottom portion and side wall of the molding container is set to 100 to 130°, and
a volume of the hydrated soybean paste filled into the container is 30% by volume of a volume of the container or more but not more than 100 mL.

8. The method according to claim 2, wherein
a water content of the hydrated soybean paste is set to 58 to 67% by weight,
the hardening by chill is carried out at such a temperature that hydrated soybean paste is expanded when a pressure is reduced in an initial stage of drying in the freeze-drying,
an angle made between the bottom portion and side wall of the molding container is set to 100 to 130°, and
a volume of the hydrated soybean paste filled into the container is 30% by volume of a volume of the container or more but not more than 100 mL.

9. The method according to claim 3, wherein
a temperature for the hardening by chill is −10 to −30° C.

10. The method according to claim 4, wherein
a temperature for the hardening by chill is −10 to −30° C.
